(19) United States
(12) Patent Application Publication
(10) Pub. No.: US 2005/0215460 A1
(43) Pub. Date: Sep. 29, 2005

(54) Solid preparations comprising a sensitive active ingredient

(75) Inventors: Georg Borchers, Bad Nauheim (DE); Manfred Schreiber, Frankfurt am Main (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 11/082,449

(22) Filed: Mar. 17, 2005

(30) Foreign Application Priority Data
Mar. 17, 2004 (DE) 102004012915.0

(51) Int. Cl. C11D 17/00

(52) U.S. Cl. 510/447

(57) ABSTRACT

Solid preparations of sensitive active ingredients which decompose with a change in the pH are claimed, said solid preparations additionally comprising an acid-base indicator.

The invention relates to solid preparations comprising one or more sensitive active ingredients which can decompose when the pH is changed, said solid preparations additionally comprising an acid-base indicator.

Solid preparations of active ingredients, for example in the form of granules, are widespread, since they are user-friendly and advantageous in performance terms.

In addition to the simple handling and meterability of granular compositions, controlled release of individual active components can be achieved depending upon granule size, granule shape, granule density, temperature, pH and solubility. Granules may consist of individual substances, optionally provided with a coating shell, or else be present as mixtures of a plurality of components. Granules have particular significance in the field of laundry detergents and cleaning compositions which comprise various active ingredients such as surfactants, bleach activators, bleach catalysts, bleach activators, soil-release polymers, enzymes, salts, optical brighteners, graying inhibitors, foam inhibitors, sequestrants and further additives and assistants, which are frequently in the form of granules. A prerequisite for the production of these granules is that the individual components do not impair one another in their effectiveness and/or stability.

However, many such active ingredients are very sensitive towards certain external influences, for example toward the influence of water or certain solvents, and decompose or change in a quite general sense, such processes proceeding with a change in the pH. Of particular significance here is the sensitivity of such active ingredients toward hydrolysis. This is especially true of bleach activators from the group of the ammonionitriles. Such a hydrolysis sensitivity of active ingredients leads to a reduced storage stability of these compounds. Attempts are being made to combat this problem by not using such active ingredients as such, but rather blending them with suitable additives and converting them to a solid form, for example by spray-drying, compression or granulation, and optionally coating them with a coating layer.

However, the development of suitable processes for granulating and stabilizing active substances is time-consuming. In particular, the analytical determination of the active substance contents of the granules in the course of the storage tests is very personnel- and time-intensive. It is therefore an object of the present invention to develop a method by which the stability of sensitive active substances can be determined in a simple manner.

This object is achieved by adding an acid-base indicator to such solid preparations.

The invention provides solid preparations of sensitive active ingredients which decompose with a change in the pH, said solid preparations additionally comprising an acid-base indicator.

Preferred sensitive active substances in the context of this invention are bleach activators, bleach catalysts, graying inhibitors, soil-release polymers, dye fixatives, dye transfer inhibitors, complexing agents or enzymes. Special preference is given to bleach activators.

The bleach activators used may be compounds which supply aliphatic peroxycarboxylic acids and/or optionally substituted perbenzoic acid under perhydrolysis conditions. Many substances are known to be bleach activators according to the prior art. Commonly, they are reactive organic compounds with an O-acyl or N-acyl group which react with the bleach, for example sodium perborate, actually in the washing powder mixture, favored by the residual moisture present, when both components are present in unprotected form.

Representative examples of bleach activators are, for instance, N,N,N′,N′-tetraacetylethylenediamine (TAED), acylated triazine derivatives, in particular 1,5-diacetyl-2,4-dioxohexahydro-1,3,5-triazine (DADHT), acylated glycolurils, in particular tetraacetylglucoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), sodium 4-benzoyloxybenzenesulfonate (SBOBS), sodium trimethylhexanonoyloxybenzenesulfonate (STHOBS), carboxylic anhydrides, in particular phthalic anhydride, acylated polyhydric alcohols, in particular triacetin, ethylene glycol diacetate, 2,5-diacetoxy-2,5-dihydrofuran and enol esters known from the documents DE 196 16 693, DE 196 16 767, and acylated sorbitol and mannitol or the mixtures thereof described in EP 525 239, acylated sugar derivatives, in particular pentaacetylglucose (PAG), pentaacetylfructose, tetraacetylxylose and octaacetyllactose, and also acylated, optionally N-alkylated, glucamine and gluconolactone, and/or lactams, for example N-benzoylcaprolactam. It is also possible to use tetraacetylcyanic acid (TACA), di-N-acetyldimethyl-glyoxime (ADMG), 1-phenyl-3-acetylhydantoin (PAH), nonanoylcaprolactamphenylsulfonate ester (APES), nitrilotriacetate (NTA) as bleach activators.

Ammonionitriles of the formula 1 form a particularly preferred class of cationic bleach activators in the context of this invention, because the problem of decomposition owing to hydrolysis is particularly serious for this substance class. Compounds of this type and their use as bleach activators in bleaches are described in EP-A-0 303 520, EP-A-0 464 880, EP-A-0 458 396, EP-A-0 897 974 and EP-A-0 790 244. 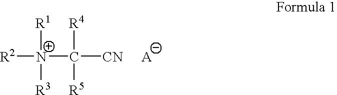
where R¹, R² and R³ are the same or different, and are each linear or branched C₁-C₂₄-alkyl groups, C₂-C₂₄-alkenyl groups or C₁-C₄-alkoxy-C₁-C₄-alkyl groups, substituted or unsubstituted benzyl, or where R¹ and R² together with the nitrogen atom to which they are bonded form a ring having from 4 to 6 carbon atoms which may be substituted by C₁-C₅-alkyl, C₁-C₅-alkoxy, C₁- to C₅-alkanoyl; phenyl, amino, ammonium, cyano, cyanamino, chlorine or bromine, and may contain, in addition to the nitrogen atom, instead of carbon atoms, one or two oxygen or nitrogen atoms, an N—R⁶ group or an R³—N—R⁶ group where R⁶ is hydrogen, C₁- to C₅-alkyl, C₂- to C₅-alkenyl, C₂- to C₅-alkynyl, phenyl, C₇- to C₉-aralkyl, C₅- to C₇-cycloalkyl, C₁- to C₆-alkanoyl, cyanomethyl or cyano, R⁴ and R⁵ are each hydrogen, C₁-C₄-alkyl, C₁-C₄-alkenyl, C₁-C₄-alkoxy-C₁-C₄-alkyl, phenyl or C₁-C₃-alkylphenyl, preferably hydrogen, methyl or phenyl, R⁴ in particular being hydrogen when R⁵ is not hydrogen, and A is an anion, for example chloride, bromide, iodide, fluoride, sulfate, hydrogensulfate, carbonate, hydrogencarbonate, phosphate, mono- and dihydrogenphosphate, pyrophosphate, metaphosphate, nitrate, methylsulfate, phosphonate, methylphoshonate, methanedisulfonate, methylsulfonate, ethanesulfonate, p-toluenephenolsulfonate, p-cumene-sulfonate.

Useful graying inhibitors include carboxymethylcellulose, methylcellulose, hydroxyalkylcellulose, methylhydroxyethylcellulose, methylhydroxypropyl-cellulose, methylcarboxymethylcellulose and polyvinylpyrrolidone.

Soil-release polymers as active substances in the context of the present invention are preferably oligoesters comprising dicarboxylic acid units and diol units (glycol, alkylglycol and/or polyol units, especially polyalkylene-polyglycol units). These oligoesters are preferably obtained by polycondensation of one or more aromatic dicarboxylic acids or esters thereof with diols, for example ethylene glycol and/or polyols. Optionally, these esters may also contain polyethylene glycol, polypropylene glycol, sulfoisophthalic acid, sulfobenzoic acid, isethionic acid, C₁-C₄-alcohols, oxalkylated C₁-C₂₄-alcohols, oxalkylated C₆-C₁₈-alkylphenols and/or oxalkylated C₈-C₂₄-alkylamines as monomers. Suitable dicarboxylic acid units for preparing the oligoesters are, for example, terephthalic acid, phthalic acid, isophthalic acid and the mono- and dialkylesters with C₁-C₆-alcohols, such as dimethyl terephalate, diethyl terephthalate and di-n-propyl terephthalate, but also oxalic acid, succinic acid, glutaric acid, adipic acid, fumaric acid, maleic acid, itaconic acid, and also the mono- and dialkyl esters of the carboxylic acids with C₁-C₆-alcohols, for example diethyl oxalate, diethyl succinate, diethyl glutarate, methyl adipate, diethyl adipate, di-n-butyl adipate, ethyl fumarate and dimethyl maleate, and also dicarboxylic anhydrides such as maleic anhydride, phthalic anhydride or succinic anhydride.

Preferred polyol units are polyethylene glycols having molar masses of from 500 to 5000, preferably from 1000 to 3000. In addition, SRPs contain, as a further component, water-soluble addition products of from 5 to 80 mol of at least one alkylene oxide to 1 mol of C₁-C₂₄-alcohols, C₆-C₁₈-alkylphenols or C₈-C₂₄-alkylamines. Preference is given to monomethyl ethers of polyethylene glycols.

Suitable alcohols which are alkoxylated are, for example, octyl alcohol, decyl alcohol, lauryl alcohol, myristyl alcohol or stearyl alcohol, but in particular methanol, and the alcohols, obtainable by the Ziegler process, having from 8 to 24 carbon atoms, or the corresponding oxo alcohols. Of the alkylphenols, octylphenol, nonylphenol and dodecylphenol in particular have significance. Of the useful alkylamines, the C₁₂-C₁₈-monoalkylamines in particular are used.

Examples of useful polyols are pentaerythritol, trimethylolethane, trimethylolpropane, 1,2,3-hexanetriol, sorbitol, mannitol and glycerol.

Also particularly suitable are the polyesters known from EP 241 985 which, in addition to oxyethylene groups and terephthalic acid units, contain 1,2-propylene, 1,2-butylene and/or 3-methoxy-1,2-propylene groups and also glycerol units, are end group-capped with C₁-C₄-alkyl groups, the soil-release-capable polymers described in EP 253 567 and having a molar mass of from 900 to 9000 g/mol, composed of ethylene terephthalate and polyethylene oxide terephthalate, the polyethylene glycol units having molar masses of from 300 to 3000 g/mol and the molar ratio of ethylene terephthalate to polyethylene oxide terephthalate being from 0.6 to 0.95, and the polyesters which are disclosed by EP 272 033 are end-group-capped at least partly by C₁-C₄-alkyl or acyl radicals and have polypropylene terephthalate and polyoxyethylene terephthalate units.

Equally preferred are oligoesters composed of ethylene terephthalate and polyethylene oxide terephthalate, in which the polyethylene glycol units have molar masses of from 750 to 5000 g/mol and the molar ratio of ethylene terephthalate to polyethylene oxide terephthalate is from 50:50 to 90:10, and whose use in laundry detergents is described in the German patent DE 28 57 292, and also oligoesters having molar masses of from 15 000 to 50 000 g/mol, composed of ethylene terephthalate and polyethylene oxide terephthalate, the polyethylene glycol units having molar masses of from 1000 to 10 000 g/mol and the molar ratio of ethylene terephthalate to polyethylene oxide terephthalate being from 2:1 to 6:1, which can be used in laundry detergents according to DE 33 24 258.

Preference is likewise given to the oligoesters, described in DE 19 644 034, of the formula 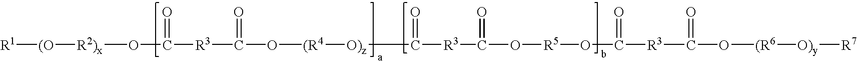
where
R¹ and R⁷ are each linear or branched C₁-C₁₈-alkyl,
R² and R⁶ are each ethylene,
R³ is 1,4-phenylene,
R⁴ is ethylene,
R⁵ is ethylene, 1,2-propylene or random mixtures of any composition of both,
x and y are each independently a number between 1 and 500,
z is a number between 10 and 140,
a is a number between 1 and 12,
b is a number between 7 and 40,
where a+b is at least equal to 11.

Preferably, each independently,
R¹ and R⁷ are each linear or branched C₁-C₄-alkyl,
x and y are each a number between 3 and 45,
z is a number between 18 and 70,
a is a number between 2 and 5,
b is a number between 8 and 12,
a+b is a number between 12 and 18 or between 25 and 35. The oligoesters described in DE 19 644 934 are obtained from dimethyl terephthalate, ethylene glycol and/or propylene glycol, polyethylene glycol and C₁ to C₁₈-alkylpolyethylene glycol with addition of a catalyst, initially by transesterification at temperatures of from 160 to approx. 220° C. and distillative removal of the methanol at standard pressure, and subsequent distillative removal of the excess glycols at temperatures of from 160 to approx. 240° C.

The invention includes dye fixatives as active substances, for example dye fixatives which are obtained by reacting diethylenetriamine, dicyandiamide and amidosulfuric acid, amines with epichlorohydrin, for example dimethylaminopropylamine and epichlorohydrin or dimethylamine and epichlorohydrin or dicyandiamide, formaldehyde and ammonium chloride, or dicyandiamide, ethylenediamine and formaldehyde or cyanamide with amines and formaldehyde or polyamines with cyanamides and amidosulfuric acid or cyanamides with aldehydes and ammonium salts, but also polyamine N-oxides, for instance poly(4-vinylpyridine N-oxide), for example Chromabond S-400 from ISP; polyvinylpyrrolidone, for example Sokalan HP 50/BASF, and copolymers of N-vinylpyrrolidone with N-vinylimidazole and optionally other monomers.

Useful dye transfer inhibitors are, for example, polyamine N-oxides, for instance poly(4-vinylpyridine N-oxide), for example Chromabond S-400 from ISP; polyvinylpyrrolidone, for example Sokalan HP 50/BASF, and copolymers of N-vinylpyrrolidone with N-vinylimidazole and optionally other monomers.

According to the invention, it is equally possible to prepare pulverulent or granular complexing agents, for example aminocarboxylates such as ethylenediamine tetraacetate, N-hydroxyethylethylenediamine triacetate, nitrilotriacetate, ethylenediamine tetrapropionate, triethylenetetraamine hexaacetate, diethylenetriamine pentaacetate, cyclohexanediamine tetraacetate, phosphonates, for example azacycloheptane diphosphonate, sodium salt, pyrophosphates, etidronic acid (1-hydroxyethylidene-1,1-diphosphonic acid, 1-hydroxyethane-1,1-diphosphonic acid, acetophosphonic acid) and salts thereof, aminophosphonates such as ethylenediamine tetrakis (methylenephosphonate), diethylenetriamine pentakis(methylenephosphonate), aminetrimethylenephosphonic acid, cyclodextrins, and polyfunctionally substituted aromatic complexing agents such as dihydroxydisulfobenzene and also ethylenediamine disuccinates.

According to the invention, enzyme granules may also form part of the subject-matter of the invention. Useful enzymes include those from the class of the proteases, lipases, amylases, pullinases, cutinases and cellulases, peroxidases or mixtures thereof. Available proteases include BLAP®, Opticlean®, Maxacal®, Maxapem®, Esperase®, Savinase®, Purafect®, OxP and/or Duraxym®, available amylases include Termamyl®, amylase-LT®, Maxamyl®, Duramyl® and/or Purafect® OxAm, and available lipases include Lipolase®, Lipomax®, Lumafast® and/or Lipozym®.

The enzymes may be adsorbed onto carrier substances and/or be embedded into coating substances.

Useful acid-base indicators are all compounds which show a color change in the pH range by decomposing with a change in the pH or changing in any other manner, for example by hydrolysis.

Available acid-base indicators include: malachite green oxalate, brilliant green, eosin yellowish, erythrosin B, methyl green, methyl violet, picric acid, cresol red, crystal violet, cresol red, m-cresol purple, thymol blue, metanil yellow, p-xylenol blue, 2,2′,2″,4,4′-pentamethoxytriphenylcarbinol, eosin bluish, quinaldine red, 2,4-dinitrophenol, 4-dimethylaminoazetobenzene, bromochlorophenol blue, Congo red, methyl orange, methyl red, ethyl red, Mortimer 4,5 mixed indicator, bromocresol green, bromocresol purple, 2,5-dinitrophenol, 2,6-dinitrophenol, 2,4-dinitrophenol, benzyl orange, tropaeolin OO, benzopurpurin 4B, dimethyl yellow, bromophenol blue, bromochlorophenol blue, α-naphthyl red, mixed indicator 5, chlorophenol red, carminic acid, alizarin red S, 2-nitrophenol, litmus, bromophenol red, 4-nitrophenol, alizarin, bromothymol blue, bromoxylenol blue, brasilin, nitrazine yellow, hematoxylin, phenol red, 3-nitrophenol, neutral red, brilliant yellow, orange 1, α-naphthophthalein, p-xylenol blue, o-cresolphthalein, phenolphthalein, α-naphtholbenzein, thymolphthalein, water blue, alizarin yellow 2G, alizarin yellow R, Nile blue A, β-naphthol violet, nitramine, tropaeolin OOO 2, tropaeolin O, epsilon blue, acid fuchsin.

The amount of acid-base indicator may be very small. It is essential that the indicator is present in such an amount that the color change is visible. In general, amounts of from 0.001 to 1% by weight of indicator, based on the active substance, are sufficient.

Solid preparations in the context of this invention are, for example, granules or compactates, or else any other solid form which is possible for active ingredients.

The inventive solid preparations are prepared by mixing one or else a plurality of active substances with one or more acid-base indicators, and it is optionally also possible to add customary granulating assistants, and this mixture is subsequently granulated by processes known per se. The active substances may be used in solid form, in the form of a melt, in suspension or in dissolved form. The same applies to the granulating assistants. The acid-base indicators may be added as a powder, as a suspension but preferably in dissolved form.

The individual components may be mixed in customary, batchwise or continuous mixer apparatus which is generally equipped with rotating mixer units, for example in a plowshare mixer for solid mixtures or in a stirred tank for liquid mixtures. Depending upon the effectiveness of the mixer apparatus, the mixing times for a homogeneous mixture are generally between 30 seconds and 5 minutes.

Depending upon the state of matter of the mixture of active substance, the indicator and any granulating assistants, various possibilities for further use arise.

In the case of a pulverulent active substance, this substance may be moistened with an aqueous solution of a granulating assistant and/or a solution of an indicator at room temperature or at elevated temperatures, and subsequently granulated and dried. A conceivable common process in this context is that of mixer agglomeration, for which, for example, ploughshare, annular bed or Schugi mixers may be used. The mixers are predominantly operated continuously, but batchwise operation is also conceivable for some mixer types.

In a second variant, the procedure may also be to spray granulating assistant and/or indicator and/or active substance onto a suitable solid support (silica). Depending upon the amount of liquid applied, a subsequent postdrying, for example in a fluidized bed dryer, may be needed. The spray application may be effected in a suitable mixer with subsequent drying or else directly in a dryer.

The preparation may also be effected in such a way that all components (active substance, indicator and any granulating assistant) are dry-mixed and granulated. A conceivable common process in this context is dry compaction on roll compacters with subsequent comminution. In one operating mode, a possibility exists of improving the compacting properties by spraying a certain amount of liquid onto the dry powder mixture before the compression. It has been found to be advantageous in this context when the indicator has been dissolved in the auxiliary liquid.

In a further preparation process, all components are mixed with one another and a plastically deformable mass is obtained by adding a plasticizer, for example polyethylene glycol, and is subsequently extruded through die bores. The thus obtained extrudates may be shortened to the desired granule lengths by using strippers, cutters or in spheronizers. Suitable apparatus for this process are, for example, edge-runner presses, shallow-die presses and extruders. The plasticizers used are very frequently water or else a meltable substance. Depending upon the plasticizer selected, a drying or cooling of the granules may be necessary after the granulation

In a further preferred embodiment, the mixture of all components is in the form of a solution or suspension which is converted to a dry form by means of a spray process. When the spray liquid is processed in a spray drying, for example in a nozzle or disk tower in cocurrent or countercurrent mode, it is possible to obtain a fine-grain powder. In fluidized bed granulation, the spray liquid is processed in a fluidized bed consisting of a carrier material and/or the product mixture to give a granule. Suitable fluidized bed apparatus has a round or rectangular design and may be operated batchwise or continuously. When the mixture of the components is present in the form of a melt, also conceivable in addition to the abovementioned spray processes with use of a cooling gas, is a solidification on cooling belts or pans. The melt may be applied in the form of a bed, of strips or by means of pelletizing technology. After the melt has solidified, a further comminution to the desired particle size may be required. The product melts may also be processed in mixers, in which case the melt is applied or sprayed onto a suitable support or a mixture of different solids, and granulated in a manner similar to wet granulation. Instead of the subsequent drying, cooling is required in this case.

The solid preparations obtained in accordance with the invention, preferably in the form of granules, are suitable directly for use in laundry detergents and cleaning compositions. However, in a further preferred form of use, they may be provided with a coating by processes known per se. To this end, the cogranule of active substances and indicator is coated with a film-forming substance in an additional step, which can considerably influence the product properties. It has been found to be advantageous when the indicator is also present in the coating. The total fraction of the indicator present in the end granule can be divided in any manner between core and coating.

Suitable coating agents are all film-forming substances, such as waxes, silicones, fatty acids, fatty alcohols, soaps, anionic surfactants, nonionic surfactants, cationic surfactants, anionic and cationic polymers, polyethylene glycols and other polyalkylene glycols.

Preference is given to using coating substances having a melting point of 30-100° C. Examples thereof and a process for the application are described in EP-A-0 835 926. The coating materials are applied generally by spraying-on the coating materials which are molten or dissolved in a solvent. The coating material may be applied to the inventive granule core in amounts of from 0 to 30% by weight, preferably from 5 to 15% by weight.

In a preferred embodiment, anionic or nonionic surfactants or polyalkylene glycols may be used as granulating assistants. Preferred anionic surfactants are alkali metal salts, ammonium salts, amine salts and salts of amino alcohols of the following compounds: alkyl sulfates, alkyl ether sulfates, alkylamide sulfates and alkylamide ether sulfates, alkylaryl polyether sulfates, monoglyceride sulfates, alkylsulfonates, alkylamidesulfonates, alkylarylsulfonates, α-olefinsulfonates, alkylsulfosuccinates, alkyl ether sulfosuccinates, alkylamidesulfosuccinates, alkylsulfoacetates, alkylpolyglycerol carboxylates, alkylphosphates, alkyl ether phosphates, alkylsarcosinates, alkylpolypeptidates, alkylamidopolypeptidates, alkylisethionates, alkyltaurates, alkylpolyglycol ether carboxylic acid or fatty acids such as oleic acid, ricinoleic acid, palmitic acid, stearic acid, salt of copra oil acid or hydrogenated salts of copra oil acid. The alkyl radical of all of these compounds contains normally from 8 to 32, preferably from 8 to 22 carbon atoms. Particular preference is given to linear straight-chain alkylbenzenesulfonates, especially having a C₈-C₂₀-alkyl group, more preferably having a C₁-C₁₃-alkyl group.

Preferred nonionic surfactants are polyethyoxylated, polypropoxylated or polyglycerolated ethers of fatty alcohols, polyethoxylated, polypropoxylated and polyglycerolated fatty acid esters, polyethoxylated esters of fatty acids and of sorbitol, polyethoxylated or polyglycerolated fatty amides.

Useful polyalkylene glycols include polyethylene glycols, 1,2-polypropylene glycols and modified polyethylene glycols and polypropylene glycols. The modified polyalkylene glycols include in particular sulfates and/or disulfates of polyethylene glycols or polypropylene glycols having a relative molecular mass between 600 and 12 000 and in particular between 1000 and 4000. A further group consists of mono- and/or disuccinates of polyalkylene glycols which in turn have relative molecular masses between 600 and 6000, preferably between 1000 and 4000. Also included are ethoxylated derivatives such trimethylolpropane having from 5 to 30 EO.

The polyethylene glycols used with preference may have a linear or branched structure, and preference is given in particular to linear polyethylene glycols. The especially preferred polyethylene glycols include those having relative molecular masses between 2000 and 12 000, advantageously around 4000, and it is possible to use polyethylene glycols having relative molecular masses below 3500 and above 5000 especially in combination with polyethylene glycols having a relative molecular mass around 4000, and such combinations advantageously have to an extent of more than 50% by weight, based on the total amount of the polyethylene glycols, polyethylene glycols having a relative molecular mass between 3500 and 5000.

The modified polyethylene glycols also include singly or multiply end group-capped polyethylene glycols, the end groups preferably being C₁-C₁₂-alkyl chains, preferably C₁-C₆, which may be linear or branched. Singly end group-capped polyethylene glycol derivatives may also correspond to the formula Cx(EO)y(PO)z where Cx may be an alkyl chain having a carbon chain length of from 1 to 20, y may be from 50 to 500 and z may be from 0 to 20.

Equally suitable are low molecular weight polyvinylpyrrolidones and derivatives of these having relative molecular masses up to a maximum of 30 000. Preference is given in this context to relative molecular mass ranges between 3000 and 30 000. Polyvinyl alcohols are preferably used in combination with polyethylene glycols.

Particular preference is given in the process according to the invention to using PEG 4000.

To improve the plasticizing and sliding properties, but also the attrition resistance of the additive granules, it is additionally possible to add one or more components which are liquid at room temperature or present as a melt under the processing conditions, for example linear or branched fatty acids or ethoxylated fatty acids having from 2 to 100 EO.

The above-described mixture of all components may additionally contain small amounts of a solvent, preferably less than 15% by weight, preferentially less than 10% by weight, more preferably less than 7% by weight.

Further suitable additives are substances which influence the pH during storage and use. They include organic carboxylic acids or salts thereof, such as citric acid in anhydrous or hydrated form, glycolic acid, succinic acid, maleic acid or lactic acid. Additionally possible are additives which influence the bleaching capacity, such as complexing agents and transition metal complexes, for example iron-, cobalt- or manganese-containing metal complexes, as described in EP-A-0 458 397 and EP-A-0 458 398.

The described addition of acid-base indicators allows monitoring in a simple manner of changes in pH in the case of sensitive active ingredients, which occur as a result of manifestations of decomposition in the course of storage, for example by hydrolysis or by other external influences. In this way, the storage stability of such sensitive active ingredients can be monitored readily. The addition of the acid-base indicators also offers a simple and easy-to-handle means of rapidly determining and selecting suitable protective additives for such sensitive active ingredients.

The invention will be illustrated in detail hereinbelow using the example of the preparation of storage-stable trimethylammonionitrile tosylate granules, without restricting the invention thereto.

Owing to its hydrolysis sensitivity, trimethylammonionitrile tosylate only has limited storage stability. Addition of additives, preferably of acidic additives, allows the hydrolysis sensitivity of the ammonionitrile to be lowered.

### EXAMPLE 1

### Screening Experiments with Trimethylammonionitrile Tosylate and Additives

In an experimental series, the intention was to determine the additives which bring about a significant improvement in the chemical stability of trimethylammonionitrile tosylate in an alkaline laundry detergent matrix.

To this end, the particular additives (see table 2) were mixed with the ammonionitrile in accordance with the weights specified in table 1, and also the indicator methyl red.

TABLE 1
Weights

| Test granule composition/% by wt. | | | Weight | | |
|---|---|---|---|---|---|
| Active substance | Additive 1 | Additive 2 | g | g | g |
| 100 | 0 | 0 | 25 | 0 | 0 |
| 90 | 10 | 0 | 22.5 | 2.5 | 0 |
| 80 | 20 | 0 | 20 | 5 | 0 |
| 76 | 15 | 10 | 18.75 | 2.75 | 2.5 |

In order to achieve very intimate association of the individual components, they were introduced into an approx. 50% aqueous ammonionitrile solution to achieve a total amount of approx. 25 g of solid. The mixture was weighed into a 500 ml Erlenmeyer flask, dissolved or homogenized, and subsequently concentrated to dryness under a gentle vacuum on a Rotavapor. Before the drying, a small amount of the methyl red indicator (from approx. 0.01 to 1% in the overall dry substance) was added to the mixture. This indicates the disruption of the acidic protective jacket by the action of the alkaline laundry detergent matrix. In the acidic range, methyl red changes from an intense red color to a yellow color (pH=4.2-pH=6.3). Subsequently, the dry residue was discharged, ground through a sieve size of 1600μ and the <630μ fraction was sieved off.

To determine the storage stability, 0.50 g of the particular dry residue was mixed with 7.00 g of “ICE-A-BASE” test detergent and 1.00 g of sodium perborate, and the reduction in the active substance content (trimethylammonionitrile tosylate) in the test formulation was monitored with reference to the color change and rated by marks.

The marks have the following meaning:
0 no discoloration active substance intact
1 slight discoloration slight degradation
2 moderate discoloration distinct degradation
3 strong discoloration only a residual content of active substance
4 full discoloration full degradation

One of the samples was stored open, without a cover, the second sample covered with a PVC film (layer thickness=0.1 mm), in a climate-controlled cabinet at 60% relative atmospheric humidity and 37° C. In the course of storage, the increase in paleness and the obtaining of the red coloration were then observed at fixed time intervals and rated with reference to marks. The results from open and closed storage of the mixtures prepared are shown by table 2.

TABLE 2
Results of the storage experiments with test mixtures

| Composition | | | | Closed storage (in days) | | | | | | | Open storage (in h) | | | |
|---|---|---|---|---|---|---|---|---|---|---|---|---|---|---|
| Active substance | Additive 1 | Additive 2 | % | 6 | 10 | 13 | 16 | 20 | 34 | 46 | 4 | 7 | 24 | 63 |
| Ammonionitrile tosylate | — | — | 100 | 1 | 2 | 3 | 4 | 4 | 4 | 4 | 0 | 0-1 | 1 | 2.5 |
| Ammonionitrile tosylate | Stearic acid | | 80/20 | 0 | 1 | 2 | 3 | 3.5 | 4 | 4 | 1 | 2 | 2.5 | 4 |
| Ammonionitrile tosylate | Sodium cumenesulfonate | | 80/20 | 0 | 0 | 0 | 0 | 2 | 3 | 4 | 0 | 1 | 2.5 | 4 |
| Ammonionitrile tosylate | PEG 4000 | | 80/20 | 2 | 2 | 2 | 2 | 3 | 4 | 4 | 1 | 2 | 4 | 4 |
| Ammonionitrile tosylate | Genapol T 500 1) | | 80/20 | 0 | 1 | 1.5 | 2 | 2.5 | 3 | 4 | 1 | 2 | 4 | 4 |
| Ammonionitrile tosylate | Sokalan PA25 CLPN 2) | | 80/20 | 0 | 0 | 0 | 0 | 0 | 1 | 2 | 0 | 0 | 2 | 4 |
| Ammonionitrile tosylate | Sokalan CP 12 S | | 80/20 | 0 | 0 | 0 | 0 | 0 | 0 | 0.5 | 0 | 0 | 1.5 | 2.5 |
| Ammonionitrile tosylate | Sokalan PA 80 S | | 80/20 | 0 | 0 | 0 | 0 | 0 | 1 | 1 | 0 | 0 | 1 | 3.5 |
| Ammonionitrile tosylate | Sokalan PA 110 S | | 80/20 | 0 | 0 | 0 | 0 | 0 | 0.5 | 1 | 0 | 0 | 0.5 | 3 |
| Ammonionitrile tosylate | Sokalan CP 13 S | | 90/10 | 0 | 0 | 0 | 0 | 0 | 0.5 | 1 | 0 | 0.5 | 1 | 3.5 |
| Ammonionitrile tosylate | Sokalan CP 13 S | | 80/20 | 0 | 0 | 0 | 0 | 0 | 0 | 0.5 | 0 | 0 | 0.5 | 2 |
| Ammonionitrile tosylate | Sokalan CP 45 | | 80/20 | 0 | 1 | 2 | 24 | 3 | 4 | 4 | 1 | 2 | 3 | 4 |
| Ammonionitrile tosylate | Glutaric acid | | 80/20 | 1 | 2 | 3 | 4 | 4 | 4 | 4 | — | — | — | — |
| Ammonionitrile tosylate | Citric acid | | 80/20 | 1 | 2 | 3 | 3 | 4 | 4 | 4 | — | — | — | — |
| Ammonionitrile tosylate | Adipic acid | | 80/20 | 2 | 3 | 3 | 3 | 3.5 | 4 | 4 | 1 | 2 | 3 | 4 |
| Ammonionitrile tosylate | Succinic acid | | 80/20 | 0 | 0 | 2 | 3 | 4 | 4 | 4 | 1 | 2 | 2.5 | 4 |
| Ammonionitrile tosylate | Succinic anhydride | | 80/20 | 2 | 3 | 3 | 3 | 3.5 | 4 | 4 | 1 | 2 | 3 | 4 |
| Ammonionitrile tosylate | Licowax KST 1) | | 80/20 | 2 | 2 | 2 | 3 | 3 | 4 | 4 | 1 | 2 | 1.5 | 4 |
| Ammonionitrile tosylate | Myristic acid | | 80/20 | 1 | 1 | 2 | 3 | 3.5 | 4 | 4 | 0 | 1 | 2.5 | 3.5 |
| Ammonionitrile tosylate | Lauric acid | | 80/20 | 3 | 3 | 3 | 0 | 3.5 | 4 | 4 | 2 | 2 | 3 | 4 |
| Ammonionitrile tosylate | Sokalan PA 25 CLPN | Fatty alcohol mixture | 80/10/10 | 0 | 0 | 0 | 0 | 0 | 0.5 | 1 | 0 | 0.5 | 2 | 3.5 |
| Ammonionitrile tosylate | Sokalan CP 12 S | Sodium | 80/10/10 | 0 | 0 | 0 | 0 | 0 | 0 | 1 | 0 | 0 | 0 | 3.5 |
| | | cumenesulfonate | | | | | | | | | | | | |
| Ammonionitrile tosylate | Sokalan CP 13 S | Sodium | 80/10/10 | 0 | 0 | 0 | 0 | 0 | 0 | 0.5 | 0 | 0 | 0 | 3 |
| | | cumenesulfonate | | | | | | | | | | | | |
| Ammonionitrile tosylate | Sokalan PA 80 S | Sodium | 80/10/10 | 0 | 0 | 0 | 0 | 0 | 0 | 1 | 0 | 0 | 0 | 3.5 |
| | | cumenesulfonate | | | | | | | | | | | | |
| Ammonionitrile tosylate | Sokalan PA 110 S | Sodium | 75/15/10 | 0 | 0 | 0 | 0 | 0 | 0.5 | 1 | 0 | 0 | 0 | 3 |
| | | cumenesulfonate | | | | | | | | | | | | |
| Ammonionitrile tosylate | Sokalan CP 12 S | Hostapur OS 1) | 75/15/10 | 0 | 0 | 0 | 0 | 0 | 0.5 | 1 | 0 | 0 | 1 | 2.5 |
| Ammonionitrile tosylate | Sokalan CP 13 S | Hostapur OS | 80/10/10 | 0 | 0 | 0 | 0 | 0 | 0 | 0.5 | 0 | 0 | 1 | 2.5 |
| Ammonionitrile tosylate | Sokalan PA 80 S | Hostapur OS | 80/10/10 | 0 | 0 | 0 | 0 | 0 | 1 | 2 | 0 | 0 | 1 | 3.5 |
| Ammonionitrile tosylate | Sokalan PA 110 S | Hostapur OS | 80/10/10 | 0 | 0 | 0 | 0 | 0 | 1 | 1.5 | 0 | 0 | 1 | 3.5 |

1) Trade name of Clariant GmbH
2) Sokalan types = trade name of BASF AG

The commercial products utilized have the following chemical constitution:

| Type | Chemical constitution | Concentration | K value | Viscosity | Molecular weight | pH |
|---|---|---|---|---|---|---|
| — | — | % by wt. | — | mPas | g/mol | — |
| Sokalan CP 45 | Maleic/acrylic acid copolymer, sodium salt; semineutralized | 45 | 60 | 6900 | 70 000 | — |
| Sokalan CP 10 S | Modified polyacrylic acid | 50 | 20 | 150 | 4000 | 4 |
| Sokalan CP 12 S | Maleic/acrylic acid copolymer | 50 | 20 | 100 | 3000 | 1.5 |
| Sokalan CP 13 S | Modified polyacrylic acid | 25 | 50 | 250 | 20 000 | 1.5 |
| Sokalan PA 25 CIPN | Polyacrylic acid, sodium salt, semineutralized | 49 | 25 | 600 | 4000 | 2 |
| Sokalan PA 80 S | Polyacrylic acid | 35 | 80 | 1000 | 100 000 | 4 |
| Sokalan PA 110 S | Polyacrylic acid | 35 | 110 | 5000 | 250 000 | 2 |
| Sokalan PA 30 Cl | Polyacrylic acid, sodium salt | 45 | 30 | 1000 | 8000 | 2 |
| Sokalan DCS | Mixture of aliphatic carboxylic acids | 100 | — | — | — | 8 |

K value: Measure of the degree of polymerization and molar mass

The thus obtained matrix allows rapid selection of promising or less interesting additives. For example, PEG 4000 is not suitable as a stabilization additive, whereas various Sokalan brands (commercial product of BASF), for example Sokalan CP 13 S, appear to be distinctly more suitable. The pure active ingredient without additive shows rapid degradation.

### EXAMPLE 2

### Preparation and Testing of Trimethylammonionitrile Tosylate Granules with Indicator

a) Preparation of a Granule without Additives

Ammonionitrile powder was initially charged batchwise with a batch size of 1 kg in a laboratory fluidized bed apparatus (Glatt GPCG-1). A two-material nozzle was used to atomize the unheated solution (solids content=50%) into the moving fluidized bed. Variation of individual operating parameters (for example spraying rate, temperature profile) allowed a 100% active ingredient granule to be obtained. Before the spraying, the methyl red indicator was added to the spray solution.

b) Preparation of a Granule with Additive

The experiment from 2a) was modified in such a way that a spray solution was used in the granulation which, in addition to the active ingredient, comprises Sokalan CP 13 S (manufacturer: BASF) as a further additive. The fluidized bed process was operated until successive exchange of the bed material and renewed spraying resulted in a granule which consisted of 90% by weight of the active substance (ammonionitrile) and 10% by weight of the Sokalan CP 13 S additive. Before the spraying, the methyl red indicator was added to the spray solution.

c) Preparation of a Coated Granule with Additive

The granule from the preliminary experiment b) was initially charged again in the fluidized bed apparatus and sprayed with a 25% aqueous solution of Sokalan CP 13 S, in order thus to achieve coating of the core granule. A total amount of 250 g of Sokalan solution was sprayed on for an initial charge of 500 g of base granule from b), so that, after the drying of the water, a granule having a composition of 80% by weight of active substance (ammonionitrile) and 20% by weight of the Sokalan CP 13 S additive was formed. Before the spraying, the methyl red indicator was added to the spray solution.

d) Testing of the Storage Stability of the Granules

The granules prepared in steps a) to c) were weighed into sample bottles for the storage test and mixed well, the mixture having the following composition:

| | | |
|---|---|---|
| Test granule | 0.50 | g |
| Test detergent “IEC-A BASE”: | 7.00 | g |
| Sodium perborate: | 1.00 | g |

For each desired storage time, a bottle was prepared and stored open in a climate-controlled cabinet at T=37° C. and 60% relative atmospheric humidity. Once per day, the bottles were agitated by rotation. After the particular storage intervals, a corresponding sample bottle was taken and assessed visually with regard to discoloration, and the active ingredient still present in the mixture was determined quantitatively (method=ion chromatography). The results obtained in this way are compiled in Table 3.

TABLE 3
Results of the storage experiments with quantitative analysis

| Sample reference | Storage time/d | | | | |
|---|---|---|---|---|---|
| — | 0 | 3 | 7 | 10 | 14 |

Visual assessment of the discoloration
by means of marks

| | | | | | |
|---|---|---|---|---|---|
| Ammonionitrile granule (100%) | 0 | 3 | 3.5 | 4 | 4 |
| Ammonionitrile granule (90%) | 0 | 2.5 | 2.5 | 3.5 | 3.5 |
| with 10% Sokalan CP 13 | | | | | |
| Ammonionitrile granule (80%) | 0 | 2 | 2.5 | 3-3.5 | 3-3.5 |
| with 20% Sokalan CP 13 | | | | | |

Active ingredient retention (quantitative)
by means of ion chromatography

| | | | | | |
|---|---|---|---|---|---|
| Ammonionitrile granule (100%) | 100 | 29.4 | 14.7 | 4.4 | 1.5 |
| Ammonionitrile granule (90%) | 100 | 39.7 | 33.3 | 11.1 | 14.3 |
| with 10% Sokalan CP 13 | | | | | |
| Ammonionitrile granule (80%) | 100 | 56.9 | 34.5 | 20.7 | 22.4 |
| with 20% Sokalan CP 13 | | | | | |

As a comparison of tables 3a) and b) shows, a good agreement was found between degree of discoloration and quantitative method. A comparison with the results of the screening tests from table 2) shows here too that the improvements found there in the storage stability as a result of the additive are confirmed in the quantitative test.

1. A solid preparation comprising at least one sensitive active ingredient which decompose with a change in the pH, said solid preparation additionally comprising an acid-base indicator.

2. The solid preparation as claimed in claim 1, wherein said sensitive active ingredient selected from the group consisting of bleach activators, bleach catalysts, graying inhibitors, soil-release polymers, dye fixatives, dye transfer inhibitors, complexing agents, enzymes, and mixtures thereof.

3. The solid preparation as claimed in claim 1, wherein said sensitive active ingredient comprises a bleach activator.

4. The solid preparation as claimed in claim 1, wherein said solid preparation comprises ammonionitriles.

5. A laundry detergent, comprising the solid preparation as claimed in claim 1.

6. A bleaching composition comprising the solid preparation of claim 1.

7. A cleaning composition comprising the solid preparation of claim 1.

8. A method for screening the stability of a solid preparation as measured by pH of said solid preparation, wherein said solid preparation comprises at least one sensitive active ingredient selected from the group consisting of a bleach activator, a bleach catalyst, a graying inhibitor, a soil release polymer, a dye fixative, a dye transfer inhibitor, a complexing agent, an enzyme, and mixtures thereof, said method comprising:
a. adding an acid-base color indicator to said solid preparation;
b. subjecting said solid preparation to stability testing wherein said solid preparation decomposes with a change in pH;
c. selecting the solid preparation having an acceptable stability according to acid-base indicator color of the solid preparation.

9. The method of claim 8, wherein said acid-base indicator has an color change range to show the change in pH.

10. The method of claim 8, wherein the acid-base indicator is added to the solid preparation in an amount effective to provide a visible color change.
